(19) United States
(12) Patent Application Publication
(10) Pub. No.: US 2015/0282218 A1
(43) Pub. Date: Oct. 1, 2015

(54) METHOD AND APPARATUS FOR ESTABLISHING AN ASA-MNO INTERFACE

(71) Applicant: QUALCOMM Incorporated, San Diego, CA (US)

(72) Inventor: Luis Fernando Brisson Lopes, Swindon (GB)

(21) Appl. No.: 14/668,342

(22) Filed: Mar. 25, 2015

Related U.S. Application Data
(60) Provisional application No. 61/973,022, filed on Mar. 31, 2014.

(51) Int. Cl. H04W 76/02; H04W 74/04; H04L 5/00; H04W 72/12; H04W 24/02

(52) U.S. Cl. CPC H04W 76/02; H04W 72/12; H04W 24/02; H04L 5/003; H04W 74/04

(57) ABSTRACT

Establishing an ASA-MNO interface is disclosed, in which, in one aspect, a policy associated with access to one or more ASA resources may be obtained by an Authorized Shared Access (ASA) controller. A communication request may be received by the ASA controller directly from a base station. In an additional aspect, a policy containing ASA information may be received by a base station. Communication with the ASA controller based on the received ASA information may be directly requested by the base station. Accordingly, a communication interface directly between the ASA controller and the base station in response to the communication request is established.

### CROSS-REFERENCE TO RELATED APPLICATIONS

This application claims the benefit of U.S. Provisional Patent Application No. 61/973,022, entitled, “METHOD AND APPARATUS FOR ESTABLISHING AN ASA-MNO INTERFACE,” filed on Mar. 31, 2014, which is expressly incorporated by reference herein in its entirety.

### BACKGROUND

1. Field

Aspects of the present disclosure relate generally to wireless communication systems, and more particularly, to an Authorized Shared Access (ASA) system for establishing an Authorization Shared Access (ASA)-Mobile Network Operator (MNO) interface directly between an ASA controller and one or more base stations.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations, node Bs, evolved node Bs (eNBs) that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

In one aspect of the disclosure, a method for wireless communication is disclosed. The method includes determining, by an Authorized Shared Access (ASA) controller, a policy containing ASA information, receiving, by the ASA controller directly from a base station, a communication request from the base station based on the ASA information, and establishing a communication interface directly between the ASA controller and the base station in response to the communication request.

In an additional aspect of the disclosure, an apparatus for wireless communication is disclosed. The apparatus includes means for obtaining a policy associated with access to one or more ASA resources, means for receiving a communication request from a base station, and means for establishing a communication interface directly between an ASA controller and the base station in response to the communication request.

In an additional aspect of the disclosure, a computer program product for wireless communications is disclosed. The computer program product includes a non-transitory computer-readable medium having program code recorded thereon. The program code includes program code to obtain a policy associated with access to one or more ASA resources, program code to receive a communication request from a base station, and program code to establish a communication interface directly between an ASA controller and the base station in response to the communication request.

In an additional aspect of the disclosure, a wireless communication apparatus is disclosed. The apparatus includes at least one processor, and a memory coupled to the at least one processor. The at least one processor is configured to obtain a policy associated with access to one or more ASA resources, to receive a communication request from a base station, and to establish a communication interface directly between an ASA controller and the base station in response to the communication request.

In an additional aspect of the disclosure, a method for wireless communication is disclosed. The method includes receiving, by a base station, a policy containing ASA information, directly requesting, by the base station, communication with an Authorized Shared Access (ASA) controller based on the received ASA information, and establishing a communication interface directly between the base station and the ASA controller.

In an additional aspect of the disclosure, an apparatus for wireless communication is disclosed. The apparatus includes means for receiving a policy containing ASA information, means for directly requesting communication with an Authorized Shared Access (ASA) controller based on the received ASA information, and means for establishing a communication interface directly between a base station and the ASA controller.

In an additional aspect of the disclosure, a computer program product for wireless communication is disclosed. The computer program product includes a non-transitory computer-readable medium having program code recorded thereon. The program code includes program code to receive a policy containing ASA information, program code to directly request communication with an Authorized Shared Access (ASA) controller based on the received ASA information, and program code to establish a communication interface directly between a base station and the ASA controller.

In an additional aspect of the disclosure, a wireless communication apparatus is disclosed. The apparatus includes at least one processor, and a memory coupled to the at least one processor. The at least one processor is configured to receive a policy containing ASA information, to directly request communication with an Authorized Shared Access (ASA) controller based on the received ASA information, and to establish a communication interface directly between a base station and the ASA controller.

### BRIEF DESCRIPTION OF THE DRAWINGS

FIG. 1 is a block diagram illustrating an example of a mobile communication system.

FIG. 2 is a block diagram illustrating a design of a base station/eNB and a UE configured according to one aspect of the present disclosure.

FIG. 3 is a block diagram showing aspects of an Authorized Shared Access (ASA) controller coupled to different wireless communication systems including one primary system and one secondary system.

FIG. 4 is a block diagram showing aspects of an ASA controller coupled to different wireless communication systems including one primary system and multiple secondary systems.

FIG. 5 is a block diagram showing aspects of an ASA controller coupled to different wireless communication systems and elements within a secondary system for supporting ASA.

FIG. 6 is a block diagram illustrating an example of communication between an Authorized Shared Access (ASA) system and eNBs in a Radio Access Network (RAN) domain.

FIG. 7 is a block diagram illustrating an example of communication between an ASA controller and eNBs in a RAN domain according to one aspect of the present disclosure.

FIG. 8 is a block diagram illustrating an example of communication among an ASA controller, a HeNB, and a HeNB Management System according to one aspect of the present disclosure.

FIG. 9 is a functional block diagram illustrating exemplary blocks executed to implement one aspect of the present disclosure.

FIG. 10 is a functional block diagram illustrating exemplary blocks executed to implement one aspect of the present disclosure.

FIG. 11 is a functional block diagram illustrating a design of an ASA controller, an eNB, and a UE in a wireless communication system according to one aspect of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The techniques described herein may be used for various wireless communication networks such as CDMA, TDMA, FDMA, OFDMA, SC-FDMA and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for LTE or LTE-A (together referred to in the alternative as “LTE/-A”) and use such LTE/-A terminology in much of the description below.

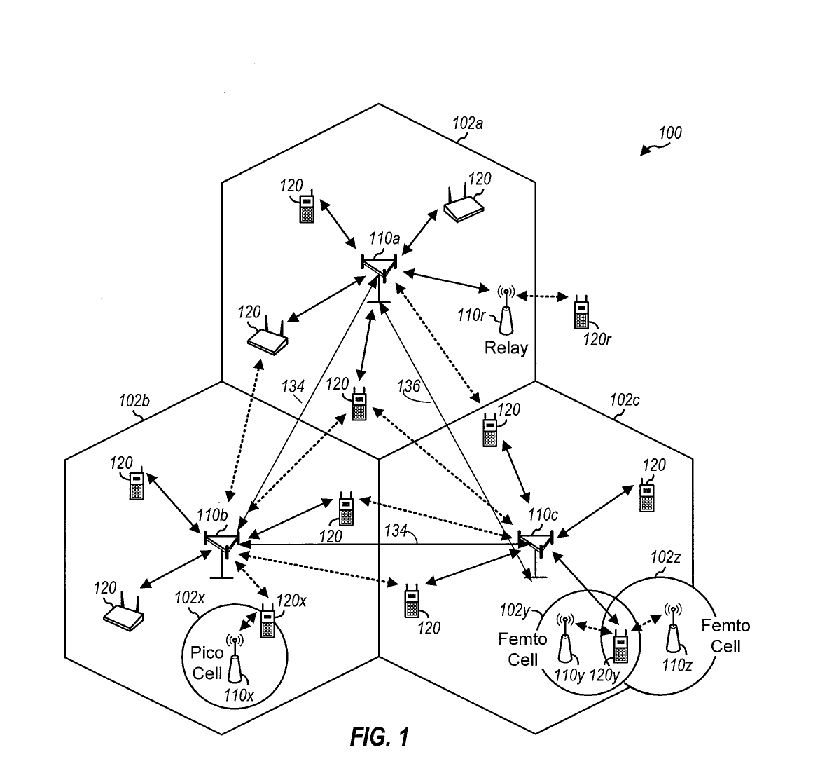

FIG. 1 shows a wireless network 100 for communication, which may be an LTE-A network. The wireless network 100 includes a number of evolved node Bs (eNBs) 110 and other network entities. An eNB may be a station that communicates with the UEs and may also be referred to as a base station, a node B, an access point, and the like. Each eNB 110 may provide communication coverage for a particular geographic area. In 3GPP, the term “cell” can refer to this particular geographic coverage area of an eNB and/or an eNB subsystem serving the coverage area, depending on the context in which the term is used.

An eNB may provide communication coverage for a macro cell, a pico cell, a femto cell, a small cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. In the example shown in FIG. 1, the eNBs 110a, 110b and 110c are macro eNBs for the macro cells 102a, 102b and 102c, respectively. The eNB 110x is a pico eNB for a pico cell 102x, serving UE 120x. And, the eNBs 110y and 110z are femto eNBs for the femto cells 102y and 102z, respectively, serving UE 120y. An eNB may support one or multiple (e.g., two, three, four, and the like) cells.

The wireless network 100 also includes relay stations. A relay station is a station that receives a transmission of data and/or other information from an upstream station (e.g., an eNB, a UE, or the like) and sends a transmission of the data and/or other information to a downstream station (e.g., another UE, another eNB, or the like). A relay station may also be a UE that relays transmissions for other UEs. In the example shown in FIG. 1, a relay station 110r may communicate with the eNB 110a and a UE 120r, in which the relay station 110r acts as a relay between the two network elements (the eNB 110a and the UE 120r) in order to facilitate communication between them. A relay station may also be referred to as a relay eNB, a relay, and the like.

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

The UEs 120 are dispersed throughout the wireless network 100, and each UE may be stationary or mobile. A UE may also be referred to as a terminal, a mobile station, a subscriber unit, a station, or the like. A UE may be a cellular phone, a smart phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE/-A utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 72, 180, 300, 600, 900, and 1200 for a corresponding system bandwidth of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands for a corresponding system bandwidth of 1.4, 3, 5, 10, 15, or 20 MHz, respectively.

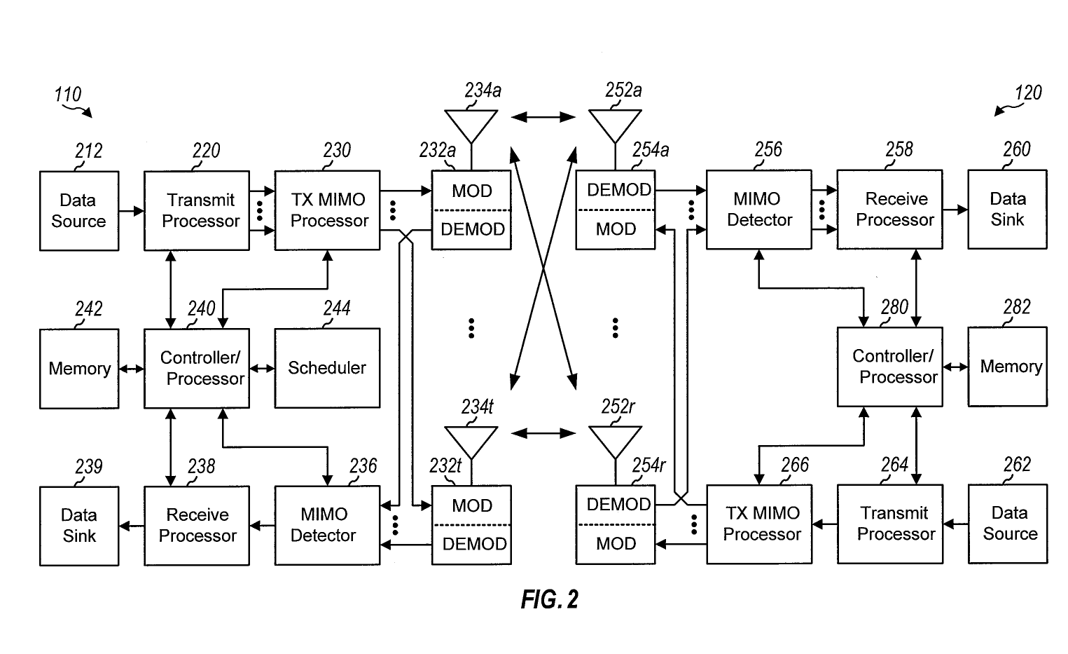

FIG. 2 shows a block diagram of a design of a base station/eNB 110 and a UE 120, which may be one of the base stations/eNBs and one of the UEs in FIG. 1. For a restricted association scenario, the eNB 110 may be the macro eNB 110c in FIG. 1, and the UE 120 may be the UE 120y. The eNB 110 may also be a base station of some other type. The eNB 110 may be equipped with antennas 234a through 234t, and the UE 120 may be equipped with antennas 252a through 252r.

At the eNB 110, a transmit processor 220 may receive data from a data source 212 and control information from a controller/processor 240. The control information may be for the Physical Broadcast Channel (PBCH), Physical Control Format Indicator Channel (PCFICH), Physical HARQ Indicator Channel (PHICH), Physical Downlink Control Channel (PDCCH), etc. The data may be for the Physical Downlink Shared Channel (PDSCH), etc. The transmit processor 220 may process (e.g., encode and symbol map) the data and control information to obtain data symbols and control symbols, respectively. The transmit processor 220 may also generate reference symbols, e.g., for the primary synchronization signal (PSS), secondary synchronization signal (SSS), and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for orthogonal frequency division multiplexing (OFDM), etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 120, the antennas 252a through 252r may receive the downlink signals from the eNB 110 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at the UE 120, a transmit processor 264 may receive and process data (e.g., for the Physical Uplink Shared Channel (PUSCH)) from a data source 262 and control information (e.g., for the Physical Uplink Control Channel (PUCCH)) from the controller/processor 280. The transmit processor 264 may also generate reference symbols for a reference signal. The symbols from the transmit processor 264 may be precoded by a TX MIMO processor 266 if applicable, further processed by the modulators 254a through 254r (e.g., for single-carrier frequency division multiplexing (SC-FDM), etc.), and transmitted to the eNB 110. At the eNB 110, the uplink signals from the UE 120 may be received by the antennas 234, processed by the demodulators 232, detected by a MIMO detector 236 if applicable, and further processed by a receive processor 238 to obtain decoded data and control information sent by the UE 120. The processor 238 may provide the decoded data to a data sink 239 and the decoded control information to the controller/processor 240.

The controllers/processors 240 and 280 may direct the operation at the eNB 110 and the UE 120, respectively. The controller/processor 240 and/or other processors and modules at the eNB 110 may perform or direct the execution of various processes for the techniques described herein. The controllers/processor 280 and/or other processors and modules at the UE 120 may also perform or direct the execution of various processes for the techniques described herein. The memories 242 and 282 may store data and program codes for the eNB 110 and the UE 120, respectively. A scheduler 244 may schedule UEs for data transmission on the downlink and/or uplink.

Authorized Shared Access (ASA)

Spectrum management is based principally on the separation of users by frequency band. A large amount of spectrum is reserved for the governmental operations, but at least some of the spectrum is not fully utilized by governmental incumbent users. The governmental incumbent users may include governmental organizations, such as a national defense organization. The governmental operations may include naval radar monitoring. However, at the same time, mobile network operators (MNOs) are facing difficulties in gaining access to additional spectrum to satisfy end users' skyrocketing data demands. Accordingly, an Authorized Shared Access (ASA) system has been suggested which offers an improved solution allowing the ASA frequency spectrum to be shared by governmental incumbent users and other entities, e.g., MNOs, to allow more efficient use of the available frequency spectrum. MNOs are allowed to access to an ASA frequency spectrum that may typically be allocated to governmental operations on a primary basis. eNBs operated by the MNO can be authorized to use the ASA frequency spectrum at the various times, locations, and frequencies when not being used by the governmental incumbent users. Also, the communication interface between governmental incumbent users and the network operated by the MNO may require a secure interface to make sure that governmental information cannot be accessed by commercial MNOs.

There are generally three conventional means by which a MNO can share ASA frequency spectrum with governmental incumbent users: (i) by geographical location—when a primary federal incumbent user operates in certain geographic areas, it is possible for the MNO to use the same ASA frequency spectrum in other geographic areas; (ii) by time sharing—when a primary federal incumbent user operates at certain times, it is possible for the MNO to use the same ASA frequency spectrum at other times; and (iii) by frequency band usage sharing—when a primary federal incumbent user operates on a certain portion of the ASA frequency spectrum, it is possible for the MNO to use the other portion of the ASA frequency spectrum.

ASA is a spectrum licensing scheme in which portions of spectrum unused by the incumbent system(s) (sometimes referred to herein as the primary licensee) are licensed to secondary licensee(s) to provide commercial services. Such arrangements may arise when it is economically beneficial to the participants. An architecture for implementing ASA is described herein, illustrating an implementation of ASA technology but not limiting the technology to the illustrated embodiments.

The following terminology is used in the present disclosure:
ASA-1 The interface between the primary licensee and the ASA controller
ASA-2 The interface between the ASA controller and the ASA network management system
ASA-3 The interface between the ASA network manager and the ASA network elements
ASA Controller The entity that receives information from the incumbent network controller on what ASA frequency spectrum is available for use by an ASA network and sends control information to the ASA network manager to notify it what ASA frequency spectrum is available
ASA Network Manager An entity operated by the ASA network operator which controls and manages its network, including but not limited to the devices operating in the ASA frequency spectrum
Secondary ASA licensee A wireless network operator that has obtained an ASA license to use ASA frequency spectrum
Authorized Shared Access A type of spectrum licensing where ASA operators utilize portions of spectrum that are unused by the primary licensee
ASA Frequency Spectrum Frequency spectrum that is not fully utilized by a primary licensee and has been licensed for use by an ASA operator. ASA frequency spectrum availability is specified by location, frequency and time.
Exclusion Zone A geographic region in which an ASA network is not permitted to operate, so as to protect an incumbent system.
Primary ASA licensee A primary licensee for a band of frequencies that continues to utilize the frequency band, but does not use the entire frequency band, in all locations at all times.
Protection zone A geographic region in which the interference from secondary ASA operation is required to be below a threshold in order to protect the primary network.
Incumbent Network An entity operated by the primary licensee which Controller controls and manages its network that operates in the ASA frequency spectrum (also sometimes referred to as Incumbent Repository)
Geographic Sharing An ASA sharing model in which the ASA network can operate throughout a geographic region for an extended period of time. The network is not permitted to operate in regions specified by exclusion zones.

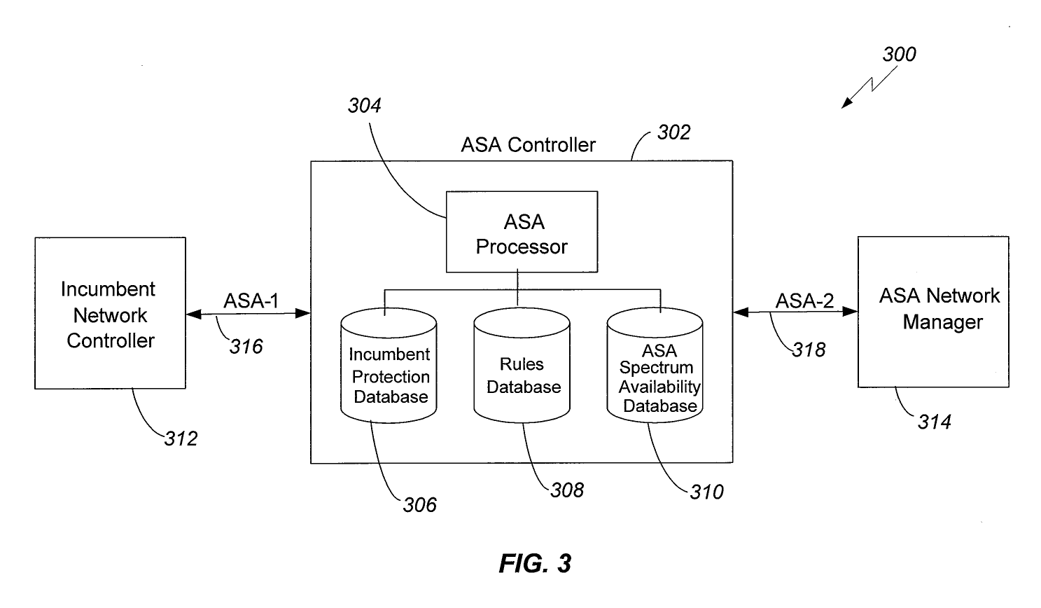

In FIG. 3, an ASA architecture 300 may include an ASA controller 302 coupled to an incumbent network controller 312 of a single incumbent system and an ASA network manager 314 of a single ASA network. The incumbent system may be a primary ASA licensee and the ASA network may be a secondary ASA licensee.

The incumbent network controller 312 is aware of how the ASA frequency spectrum is used by the incumbent system at specified times and locations. The incumbent network controller provides information to the ASA controller 302 on the incumbent usage of the ASA frequency spectrum. There are several methods that the incumbent network controller 312 can use to provide this information to the ASA controller 302. For example, the incumbent network controller 312 may specify a set of exclusion zones along with exclusion times. Another option is for the incumbent network controller 312 to specify the maximum allowed interference at a set of locations. The incumbent network controller 312 may send this incumbent protection information to the ASA controller 302 over an ASA-1 interface 316, aspects of which are described in more detail below. Incumbent protection information may be stored by the ASA controller 302 in a database 306.

The ASA controller 302 uses the information from the incumbent network controller 312 to determine what ASA frequency spectrum can be used by the ASA network. The method used by the ASA controller 302 to determine what ASA frequency spectrum may be used at any given time for any given location may utilize a set of rules specified in a rules database 308 accessed by an ASA processor 304. The rules database 308 stores the regulatory rules that may be set by local regulations. These rules may not be modified through either the ASA-1 or the ASA-2 interfaces, and may be updated by the individual or organization that manages the ASA controller 302. ASA frequency spectrum availability, as calculated using the rules in the rules database 308, may be stored in the ASA frequency spectrum availability database 310.

The ASA controller 302 may send information to the ASA network manager 314 on what ASA frequency spectrum is available via an ASA-2 interface 318, based on the spectrum availability database. The ASA network manager 314 may know or determine the geographic location of base stations under its control and also information about the transmission characteristics of these base stations, including transmit power, supported frequencies of operation, etc. The ASA network manager 314 may query the ASA controller 302 to discover what ASA frequency spectrum is available in a given location or a geographic region. Also, the ASA controller 302 may notify the ASA network manager 314 of any updates to the ASA frequency spectrum availability in real-time. This allows the ASA controller 302 to notify the ASA network manager 314 if ASA frequency spectrum is no longer available, so that the ASA network can cease using that spectrum, so that the incumbent network controller 312 can obtain exclusive access to the ASA frequency spectrum via real time configuration changes.

The ASA network manager 314 may be embedded in a standard network element, depending on the core network technology. For example, if the ASA network is a long term evolution (LTE) network, then the ASA network manager may be embedded in an Operations, Administration and Maintenance server (OAM). More information about interfaces ASA-1 and ASA-2 can be found in the disclosure below.

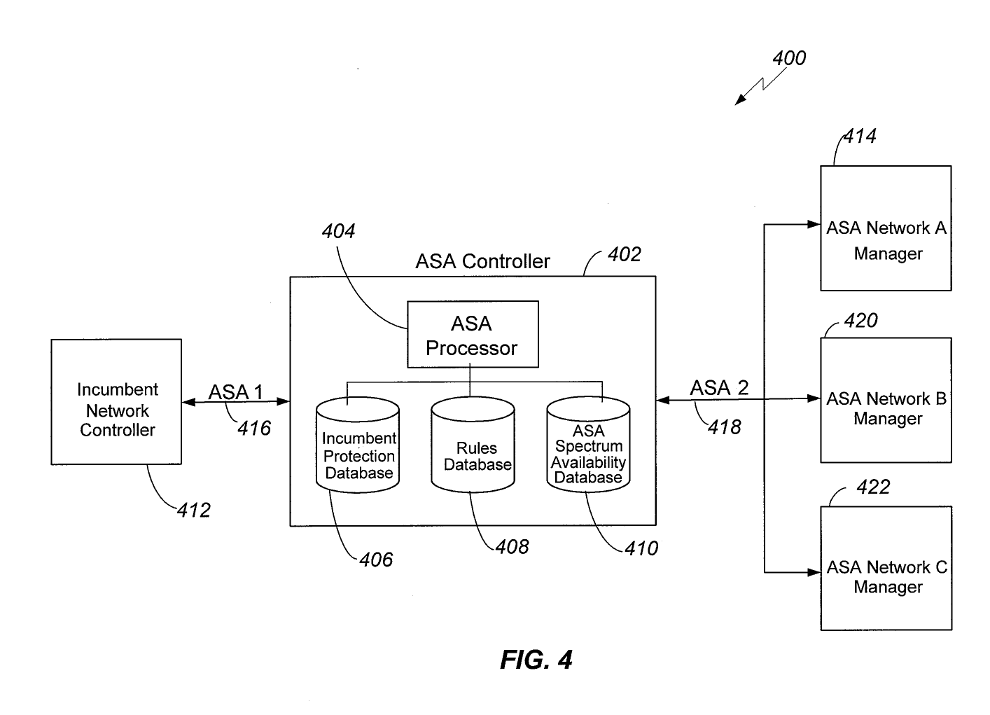

In FIG. 3, a single incumbent network controller and a single ASA network manager, both connected to the ASA controller, are illustrated. It is also possible for multiple ASA networks (e.g., ASA network A, ASA network B and ASA network C) to be connected to an ASA controller 402, as in a system 400 shown in FIG. 4. FIG. 4 is a block diagram illustrating an ASA architecture 400 that includes multiple ASA networks coupled into an ASA controller. ASA network A includes an ASA network A manager 414 coupled to the ASA controller 402, ASA network B includes an ASA network B manager 420 coupled to the ASA controller 402, and ASA network C includes an ASA network C manager 422 coupled to the ASA controller 402. In this case, the multiple ASA networks may share the same ASA frequency spectrum. There are several ways in which this sharing of the ASA frequency spectrum can be accomplished. One method is for in a given region, each network is restricted to a subband within the ASA frequency spectrum. How each ASA network obtains rights to each subband is outside the scope of this document and should be addressed during the spectrum auctioning process. Another method for the ASA networks to share the ASA frequency spectrum may employ using tight timing synchronization and scheduling of the channel access by the different networks. This ASA sharing approach has been studied for LTE networks, as an example. The system 400 may further include an incumbent network controller 412 of an incumbent system communicating with the ASA controller 402 via an ASA-1 interface 416, to provide incumbent protection information for a database 406 (similar to the database 306 in FIG. 3). The ASA controller 402 may include a processor 404 coupled to a rules database 408 (similar to the rules database 308 in FIG. 3) and ASA frequency spectrum availability database 410 (similar to the ASA frequency spectrum availability database 310 in FIG. 3). The ASA controller 402 may communicate with the ASA network managers 414, 420 and 422 via an ASA-2 interface 418. The incumbent system may be a primary licensee, and the ASA networks A, B, C may be secondary licensees.

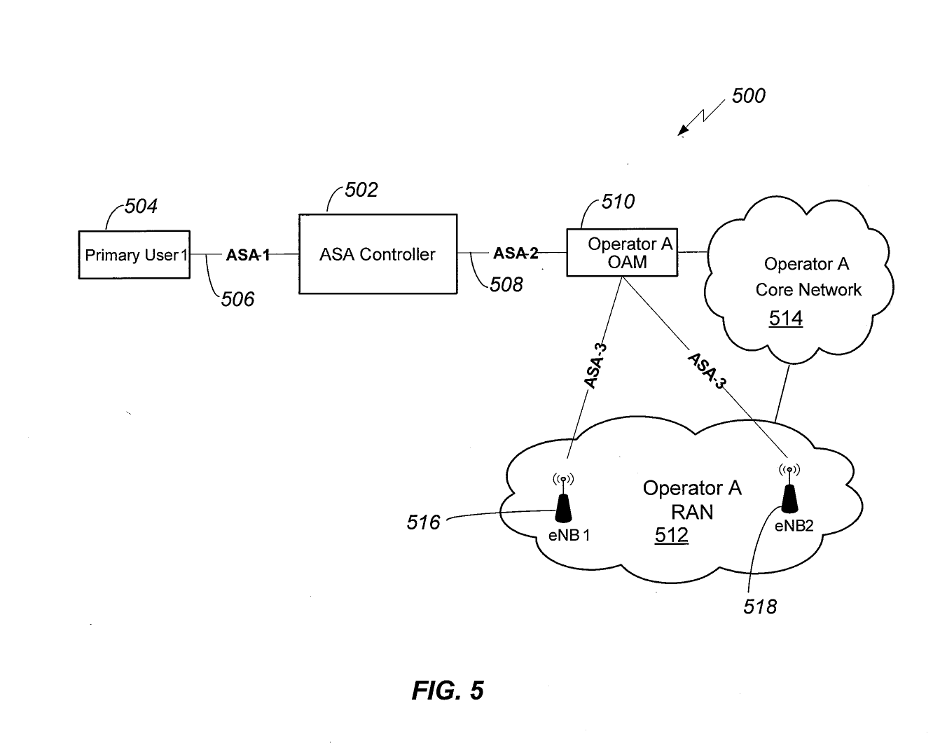

The ASA network manager(s) may need to interact with various network elements, such as eNBs to achieve the desired spectrum use control. This can be facilitated by the use of an ASA-3 interface as shown in FIG. 5, showing a system 500 including ASA-3 interfaces between the eNBs 516, 518 in the Radio Access Network 512 and an ASA network manager node embedded in an OAM 510. The Radio Access Network 512 may be coupled to a core network 514. An ASA controller 502 may be coupled to the OAM 510 via an ASA-2 interface 508 and to a primary user (licensee) node (e.g., incumbent network controller) 504 via an ASA-1 interface 506.

It is also possible to have multiple incumbent network controllers 504 for the same ASA frequency spectrum. Ideally, a single incumbent network controller can provide complete information about incumbent protection for a given ASA frequency band. For that reason, the architecture may be limited to a single incumbent network controller. However, it is noted that multiple incumbent network controllers may be supported, but it may be more straightforward and more secure to limit it to a single incumbent network controller.

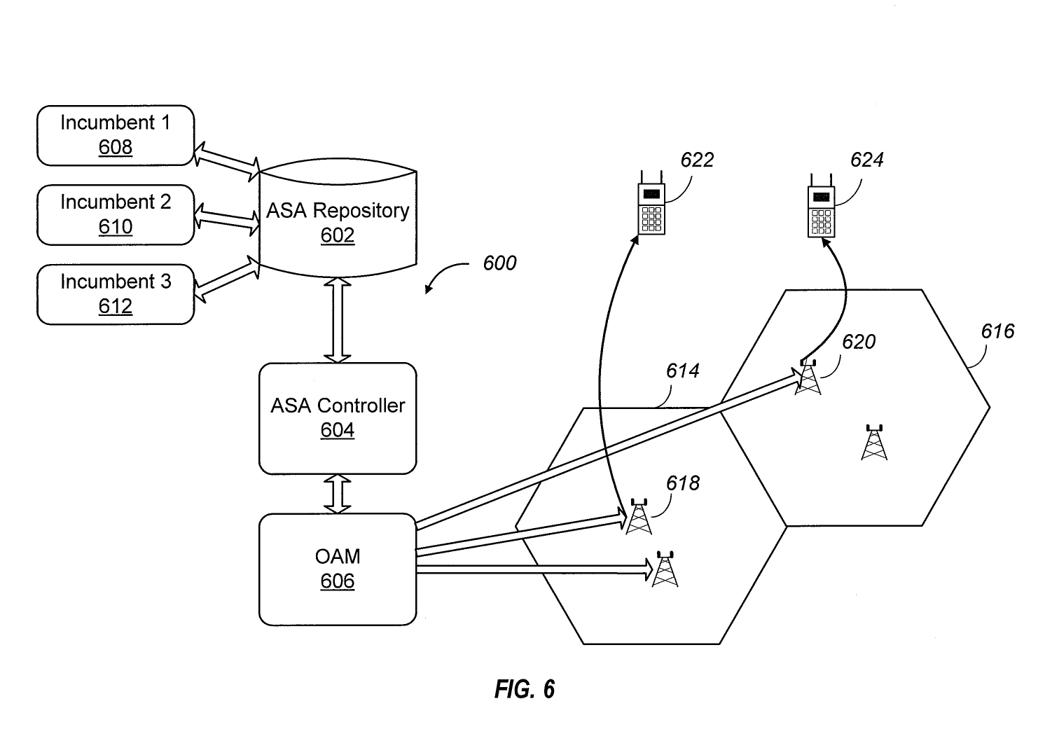

FIG. 6 is a block diagram illustrating an example of communication between an ASA system 600 and eNBs 618 and 620 in a Radio Access Network (RAN) domain. The ASA system 600 includes an ASA repository 602 and an ASA controller 604. Incumbent users 608, 610, and 612 disclose time-varying requirements to the ASA system 600. The usage of the ASA frequency spectrum by the incumbent users 608, 610, and 612 may be stored in the ASA repository 602. The ASA controller 604 may then use the usage information stored in the ASA repository 602 to determine availability of ASA frequency spectrum and grant resources to a MNO accordingly. The ASA controller 604 may maintain tight control of the MNO's use of the ASA frequency spectrum. For example, the ASA controller 604 may specify availability of the ASA frequency spectrum in a given location, within a particular frequency band, or at a particular time, and the maximum power limit for a given base station. The ASA controller 604 can minimize MNO interference with federal operations, and may also minimize interference by the federal operations with the MNO operations.

In FIG. 6, the ASA controller 604 does not communicate with the eNBs 618 and 620 directly. Instead, the ASA controller 604 provides information about availability of the ASA frequency spectrum to an Operation, Administration, and Maintenance server (OAM) 606 of the MNO. The OAM 606 translates this information into Radio Resource Management commands and transmits the commands to the eNBs 618 and 620 in a MNO's Radio Access Network (RAN) domain. However, not all base stations/eNBs may be granted access to the ASA system 600. For example, the eNB 618 is located in a first cell 614 operating on the ASA frequency spectrum and a MNO's spectrum. Therefore, the eNB 618 would enable an user equipment (UE) 622 to utilize both the ASA frequency spectrum and the MNO's spectrum. Further, the OAM 606 may also be able to instruct eNB 618 to seamlessly hand over the UE 622 to other non-ASA frequency spectrum or to power down the UE 622 when federal incumbent users need to use the same ASA frequency spectrum. On the contrary, the eNB 620 is located in a second cell 616 operating only on the MNO's spectrum. Therefore, the UE 624 would only be able to use the MNO's spectrum.

The communication structure between the ASA system 600 and the eNBs 618 and 620 in the RAN domain, as illustrated in FIG. 6 may still have potential issues. For example, the current interface between the ASA system 600 and the MNO relies on the OAM 606. This approach may fully rely on operations of the OAM 606. However, the OAM 606 is typically designed to handle the static configurations of eNBs, and is not designed to handle the dynamic changes in spectrum availability that may impact a large number of eNBs. For another example, changes in the incumbents' requirements on spectrum use may impact a large number of eNBs. For example, a change in maximum transmit power may impact a large number of eNBs which need power adjustments. The situation may be even more complicated in the case of small cell deployments, where the numbers of eNBs can be quite large and can cause scalability issues. Because of the large number of eNBs, there would be a resulting large number of eNB configuration change related to ASA. It would also be difficult to optimize the power transmitted in areas where it is possible to transmit, but under restrictions of which eNBs to select, etc. As a result, the mechanism to trigger changes to the eNBs may need to be centralized at the ASA controller 604. However, such centralized operations may be contrary to the trend of self-optimizing networks (SONs). In a SON, cells may be locally turned off and on in a dynamic matter, or local parameters may be changed by each eNB, and such local actions would only impact a small number of cells at one time.

As an alternative to using an OAM interface, existing interfaces may be used to transport protocol exchanges between the eNBs and the ASA controller. For example, such exchanges might be transported over an S1c interface (eNB to/from Mobility Management Entity (MME)), and a new interface defined between the ASA controller and MME to facilitate the communication between the eNBs and the ASA controller. Although this approach is possible, the existing S1 interface and the MMEs may be impacted, and may require the ASA controller to have connectivity to all the MMEs. As a result, with such an approach, ASA introduction would go along with upgrades of both the Core Network (CN) and the RAN, as well as the MNO's OAM. Also, routing of the communication between the controller and each eNB would be complex because the ASA controller would continue routing information on each eNB including Tracking Area Code (TAC)/Tracking Area Identity (TAI) or the MME(s) that serve the eNB. The amount of routing information can be large and is difficult to maintain up-to-date as the mobile network is often reconfigured or expanded. As such, various aspects of the present disclosure propose a new interface between the ASA system and the MNO that does not require involvement of the CN and the OAM, such as upgrades of the CN and the OAM, for real-time handling the reconfiguration commands to all base stations/eNBs.

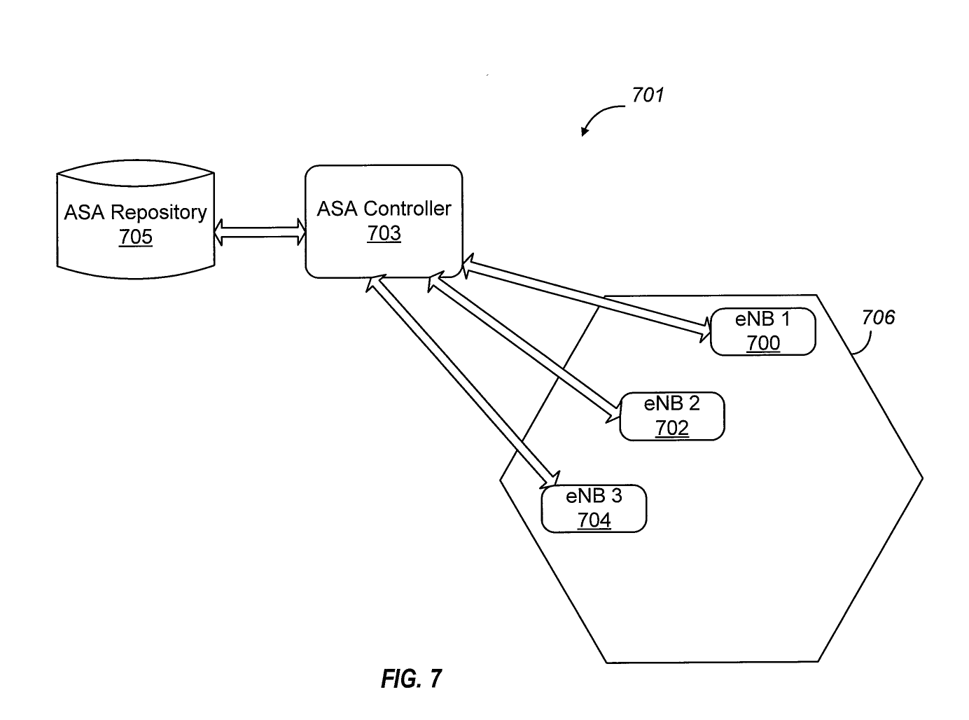

FIG. 7 is a block diagram illustrating an example of communication between an ASA controller 703 and the eNBs 700, 702, and 704 in a RAN domain 706 according to one aspect of the present disclosure. Each of eNBs 700, 702, and 704 operated by a MNO may directly communicate with the ASA controller 703 according to policies set by an OAM of the MNO. For example, the eNBs 700, 702, and 704 may directly request communication with the ASA controller 703 and the ASA controller 703 may receive a communication request directly from the eNB 700, 702, and 704 without passing communications through the OAM or other such intermediate network entity, as illustrated in FIG. 6. In existing operations, an ASA controller only communicates with the OAM, as the endpoint of all of the ASA information in the operator's network. However, according to the various aspects of the disclosure, direct communication from the ASA controller occurs with the network eNBs without any intervening communication through or with the OAM. The OAM may no longer be required to handle dynamic changes in spectrum availability or other related system information. ASA frequency spectrum and related system information may be exchanged between the eNBs 700, 702, and 704 and ASA controller 703 without being processed by the OAM. Accordingly, the OAM or similar network entities may not be required to establish communication between the eNBs 700, 702, and 704 and the ASA controller 703. An ASA-MNO communication interface may be established directly, as noted above without communication through the OAM or other such intermediate network entity, between the ASA controller 703 and the eNBs 700, 702, and 704 in the RAN domain and handle real-time configuration changes. The ASA-MNO communication interface may include a Stream Control Transmission Protocol/Internet Protocol (SCTP/IP) interface for increased reliability. The SCTP/IP interface between the ASA controller 703 and the eNBs 700, 702, and 704 may be kept active as per normal SCTP operation, enabling changes in status to be communicated by either the ASA controller 703 or the eNBs 700, 702, and 704.

In some aspects, the ASA controller 703 may be coupled with an ASA repository 705. The ASA controller 703 may obtain usage information of the ASA frequency spectrum that may have been used or is currently being used by incumbent users from the ASA repository 705.

The eNBs 700, 702, and 704 may directly request communication with the ASA controller 703 to establish a communication interface. Further, the eNBs 700, 702, and 704 may directly request to use ASA resources, such as an ASA frequency spectrum. For example, the eNBs 700, 702, and 704 may directly request to use ASA resource without relying on operations of the OAM. Correspondingly, the ASA controller 703 may directly respond to communication requests from the eNBs 700, 702, and 704 by establishing a communication interface with the eNBs 700, 702, and 704 and/or allowing the eNBs 700, 702, and 704 to directly register themselves with the ASA controller 703. The ASA controller 703 may directly prompt the eNBs 700, 702, and 704 to register themselves with the ASA controller 703 without relying on operations of the OAM. Further, the ASA controller 703 may directly respond to resource requests from the eNBs 700, 702, and 704 with availability of ASA frequencies/carriers requested by the eNBs 700, 702, and 704 based on the current situation at the time of the request. Resource requests may be piggybacked on communication requests or may be separated from communication requests. When resource requests are piggybacked on communication requests, the eNBs 700, 702, and 704 may not be required to send a separate request for ASA resources before or after the communication interface established between the eNBs 700, 702, 704 and ASA controller 703. Resource requests from the eNBs 700, 702, and 704 may be responded to by the ASA controller 703 after the communication interface is established between the eNBs 700, 702, and 704 and the ASA controller 703. The communication and resource requests and responses may be determined based on policies received by the eNBs 700, 702, and 704 and determined by the ASA controller 703, respectively.

In some aspects, the eNBs 700, 702, and 704 may detect the status of the SCTP interface, as known in the art. If the interface fails, the eNBs 700, 702, and 704 may try to restore the interface. If the eNBs 700, 702, and 704 fail to restore the interface, the eNBs 700, 702, and 704 may still be able to operate in the RAN domain 706 while ASA operation may be discontinued according to an existing policy for fall-back in case of failure of the interface. This may consist of discontinuing all use of the ASA frequencies, or continuing use of the ASA frequencies with certain restrictions.

In some aspects, when an eNB has been granted use of the ASA frequency spectrum, the ASA controller 703 may reject communication and/or resource requests from other base stations if the eNB that is currently granted use of the ASA frequency spectrum has higher priority to use the ASA frequency spectrum than the other base stations. However, if the eNB that is currently granted use of the ASA frequency spectrum has lower priority to use the ASA frequency spectrum than the other base stations, the ASA controller 703 may execute pre-emption. In such a case, when an eNB with lower priority is currently using ASA frequency spectrum, and an eNB with higher priority requests ASA resources, the ASA controller 703 may not be able to grant access to the higher priority eNB because of the existing use by the lower priority eNB. The ASA controller 703 may then determine whether, by turning off ASA frequency use by the lower priority eNB, the situation changes such that the higher priority eNB access to the ASA resources could be granted.

In FIG. 7, the eNBs 700, 702, and 704 may receive one or more policies containing ASA information from the OAM of the MNO (not shown in FIG. 7) in the RAN domain 706 and request communication directly with ASA controller 703 based on received ASA information. The eNBs 700, 702, and 704 may examine the one or more policies to decide whether to communicate directly with the ASA controller 703 to request to access the ASA system 701 in order to utilize the ASA frequency spectrum. Correspondingly, the ASA controller 703 may determine one or more policies from the OAM of the MNO (not shown in FIG. 7) in the RAN domain 706 and directly respond to communication and resources requests from the eNBs 700, 702, and 704 operated by the MNO based on the determined policies including ASA information. The ASA controller 703 may be programmed with the one or more policies or receive the one or more policies from the OAM of the MNO. The ASA controller 703 may be located in the RAN domain 706 controlled by the MNO or in a domain controlled by a governmental organization, or it may be controlled by a trusted third-party. Either eNBs 700, 702, and 704 or the ASA controller 703 may initiate the communication and prepare to establish a communication interface between the eNBs 700, 702, and 704 and the ASA controller 703 accordingly.

The policy received by the eNBs 700, 702, and 704 may include ASA information. The ASA information may be an ASA configuration which indicates an ASA frequency spectrum and potential availability of the ASA frequency spectrum to one or more eNBs, 700, 702, and 704, an identity of the ASA controller 703 for the eNBs 700, 702, and 704 to contact for each ASA frequency in the ASA frequency spectrum or geographical area, e.g., IP address or addresses, priority levels associated with resource requests from the eNBs 700, 702, and 704, a group label indicating a set of base stations or an area including multiple base stations such that they are treated collectively, a condition under which the eNBs 700, 702, and 704 may initiate resource requests, and expectation of the availability of the ASA frequency spectrum in general, or in the area of each eNB. The ASA configuration may further specify one or more particular frequencies which the eNBs 700, 702, and 704 and their cells and sectors are allowed to use based on status of the eNBs 700, 702, and 704, e.g., eNBs' location or traffic status. Expectation of the availability of the ASA frequency spectrum may be generated by the OAM based on historical data or commercial agreements and used by the eNBs 700, 704, and 704 to decide whether or not to attempt to access to the ASA frequency spectrum. The expectation of the availability of the ASA frequency spectrum may be related to the chances that the eNBs 700, 702, and 704 may be granted access to the ASA frequency spectrum. The eNBs 700, 702, and 704 may examine the ASA frequency spectrum information to decide whether to communicate directly with the ASA controller 703 to request to access the ASA system 701 in order to utilize the ASA frequency spectrum.

The policy determined by the ASA controller 703 may be used to manage conflicts among a plurality of eNBs. The policy determined by the ASA controller 703 may include ASA information. The ASA information may be an ASA configuration which indicates an ASA frequency spectrum and potential availability of the ASA frequency spectrum to one or more eNBs, such as 700, 702, and 704.

Further, the policy determined by ASA controller 703 may include several rules. Some rules may indicate how ASA controller 703 prioritizes resource requests from the eNBs 700, 702, and 704. Such rules may help the ASA controller 703 decide whether particular ASA frequencies can be assigned to particular eNBs, if the full set of ASA resources cannot be assigned to all eNBs. This prioritization may be accomplished by making use of priority levels associated with resource requests from the eNBs 700, 702, and 704. The priority levels of resource requests may be provided by the eNBs 700, 702, and 704 within the requests themselves, or may be determined based on locations or characteristics of the eNBs 700, 702, and 704, e.g., cell type (macro cell, pico cell, etc.). The ASA controller 703 may provide different ASA frequencies to a macro cell and a micro cell in the same area based on the priority levels of the macro cell and the micro cell. Some rules may indicate how the ASA controller 703 responds to resource requests from the eNBs that have been indicated by the group label. The eNB may only be accepted by the ASA controller 703 if all the other eNBs indicated by the same group label are allowed to use the same ASA frequency. For example, if the eNBs 700, 702, and 704 are all labeled by the same group label, none of the eNBs 700, 702, and 704 may be accepted by the ASA controller 703 if any of the eNBs 700, 702, and 704 is not allowed to use the ASA frequency indicated by the group label. Such rules may be used to ensure that a certain frequency is available across a set of contiguous eNBs, thus facilitating mobility across adjoining cells. Some rules may indicate how the ASA controller 703 responds to each of the resource requests from the eNBs 700, 702, and 704.

In some aspects, the policy determined by the ASA controller 703 and received form the OAM of the MNO may include one or more potential network configurations for usage of the ASA frequency spectrum. The ASA controller 703 may select a network configuration from the one or more potential network configurations. The network configuration may indicate information and status of one or more eNBs in the MNO.

In some aspects, the ASA controller 703 may receive information directly from the eNBs 700, 702, and 704, such as locations, cell parameters, priority levels, and labels of the eNBs 700, 702, and 704 and one or more frequencies which the eNBs 700, 702, and 704 request to use. Such information from the eNBs 700, 702, and 704 may be included in communication and/or resource requests directly from the eNBs 700, 702, and 704. The one or more frequencies requested by the eNBs 700, 702, and 704 may be prioritized by the policy provided by the OAM.

In some aspects, the OAM may change priority levels of resource requests or group labels assigned to the eNBs 700, 702, and 704. Changes to priority levels of resource requests or group labels may indirectly change how communication and resource requests from the eNBs 700, 702, and 704 be responded and processed by the ASA controller 703.

In some aspects, the OAM may collect usage data and statistics of the ASA system 701, such as actual usage of the ASA frequency spectrum, from time to time. The OAM may further program the ASA controller 703 with possible policies of the MNO if ASA controller 703 is a part of the OAM of the MNO. Accordingly, the ASA controller 703 may be able to select one of the possible policies that meets current operational constraints. The OAM may also be able to change policies or ASA configuration based on operational changes reported from the eNBs 700, 702, and 704.

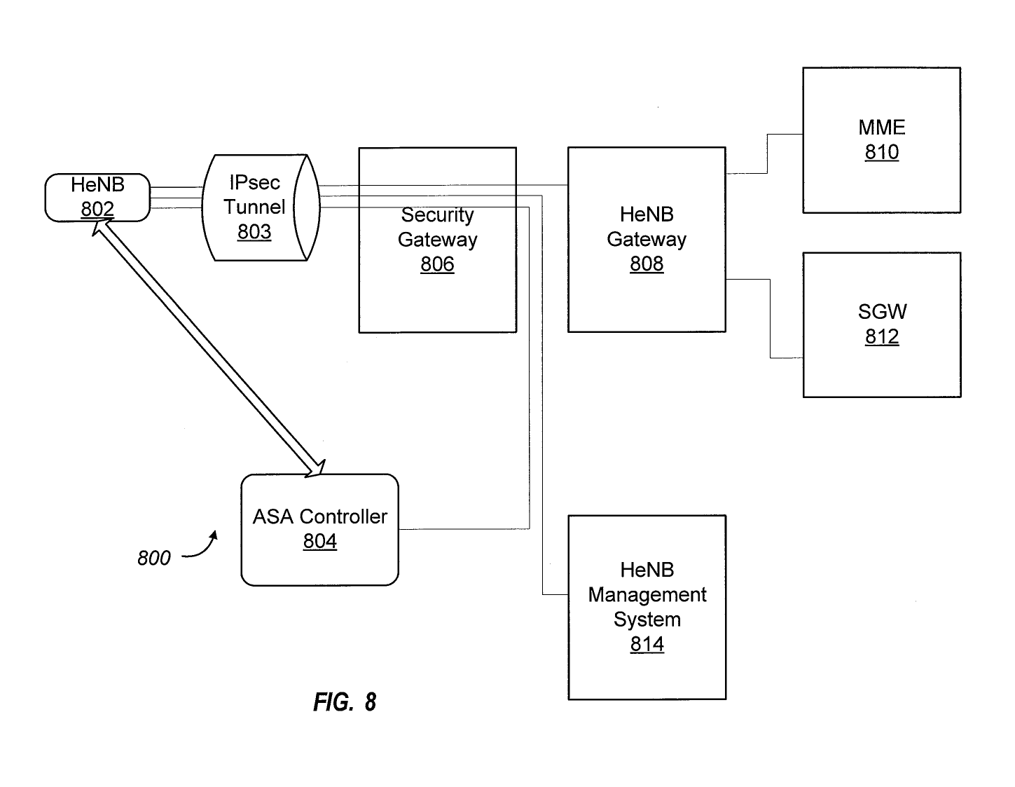

FIG. 8 is a block diagram 800 illustrating an example of communication among an ASA controller 804, a HeNB 802, and a HeNB Management System 814 according to one aspect of the present disclosure. The ASA system 701 may not only be able to provide communication in a macro cell or a pico cell, as illustrated in FIG. 7, but also be able to provide communication in a femto cell, as illustrated in FIG. 8. In FIG. 8, the HeNB 802 may directly communicate with the ASA controller 804 in a way illustrated above with respect to FIG. 7, with the difference that in a femto network, such communication may typically run over a secure path as shown in FIG. 8. However, in a femto network, the one or more policies may be received from the HeNB management system 814. The HeNB Management System, also known as an AutoConfiguration Server (ACS), may provide ASA configuration information to the HeNB 802 via a security gateway 806 and an IPsec tunnel 803. The security gateway 806 and the IP security (IPsec) tunnel 803 may also be a gateway for the HeNB 802 to communicate with an HeNB gateway 808, a mobility management entity (MME) 810, and an serving gateway (SGW) 812. The structure illustrated in FIG. 8 may not require a change to existing communication standards between the HeNB 802 and the HeNB Management System 814.

It should be noted that the various aspects of the present disclosure are not limited to specific numbers of ASA controllers, eNBs, UEs, MNOs, and OAMs.

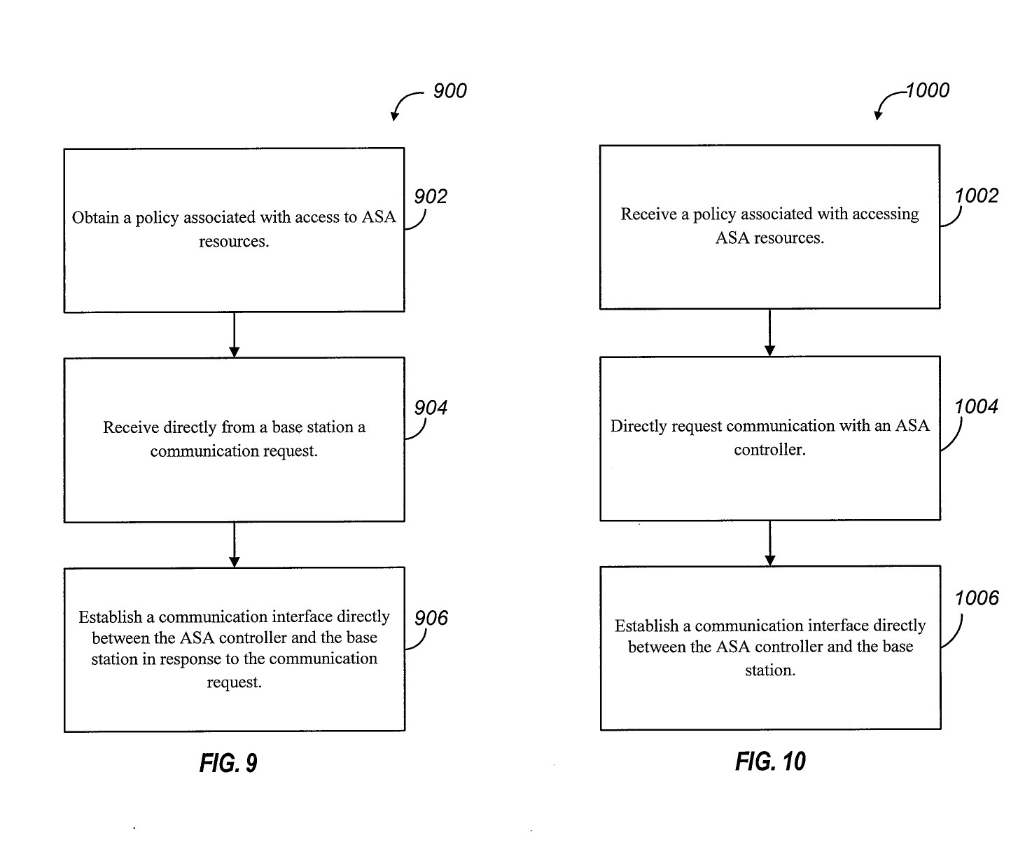

FIG. 9 is a functional block diagram illustrating exemplary blocks executed to implement one aspect of the present disclosure. The functional block diagram 900 may be implemented by an ASA controller, such as the ASA controller 703 or 804 illustrated in FIGS. 7-8. At block 902, the ASA controller may obtain a policy containing ASA information. The policy may be provided by an OAM of a MNO, programmed in the ASA controller, or the like. At block 904, the ASA controller may receive directly from one or more base stations a communication request based on the ASA information. At block 906, the ASA controller may establish a communication interface directly between the ASA controller and the base station in response to the communication request. The interface may be established according to SCTP standards, as known in the art. An internet protocol (IP) path may be set up between the ASA controller and the relevant base stations, followed by an initialization message from the eNB providing relevant connection information, such as its identifier, frequencies, and the like, to which the ASA controller would respond.

It should be noted that, in additional or alternative aspects, the ASA controller may use the ASA information to determine whether direct communication with this particular base station should be allowed.

FIG. 10 is a functional block diagram illustrating exemplary blocks executed to implement one aspect of the present disclosure. The function block diagram 1000 may be implemented by an eNB, such as eNBs 700, 702, or 704 illustrated in FIG. 7 or the HeNB 802 illustrated in FIG. 8. At block 1002, the eNB may receive a policy containing ASA information. The policy may be provided by an OAM of a MNO or may be reconfigured directly into the base station or eNB controlling logic. At block 1004, the eNB may directly request communication with an ASA controller based on received ASA information. The eNB may be operated by the MNO and request to access an ASA system in order to utilize an ASA frequency spectrum. The eNB may examine the policy to decide whether to request the direct communication with the ASA controller. For example, the policy may provide conditions under which the eNB may request ASA resources, and the eNB may decide to establish the interface if those conditions are already met, or if the eNB expects such conditions to be met in the future based on traffic statistics. At block 1006, the base station may establish a communication interface directly between the base station and the ASA controller.

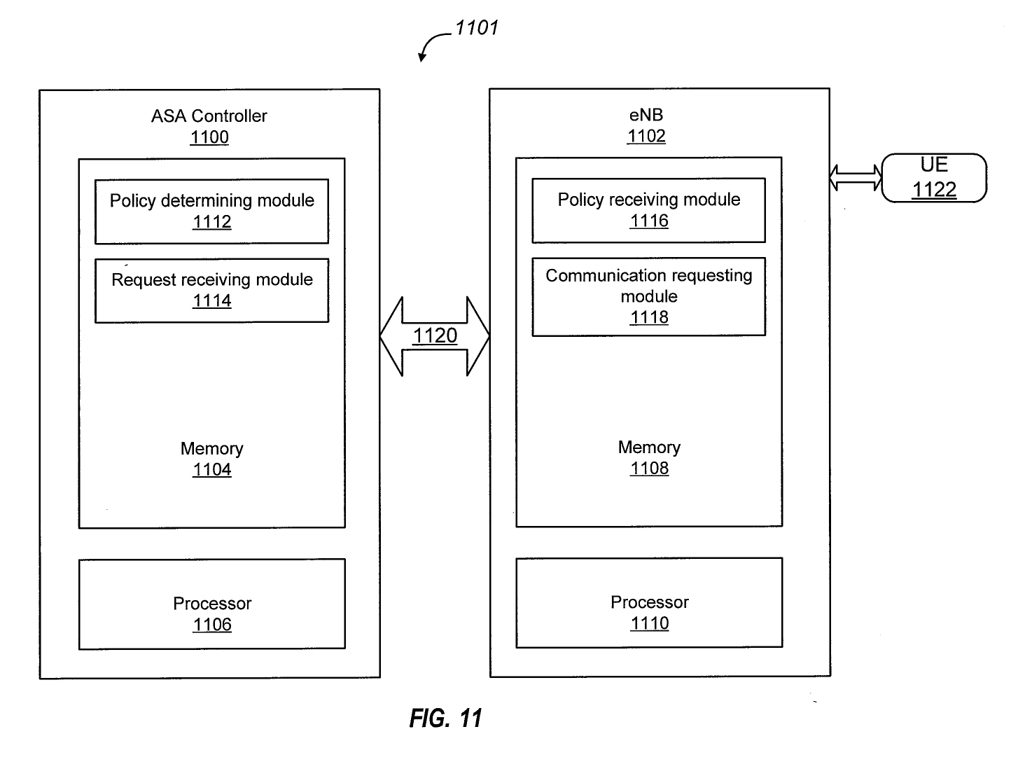

FIG. 11 is a functional block diagram illustrating a design of an ASA controller 1100, an eNB 1102, and a UE 1122 in a wireless communication system 1101 according to one aspect of the present disclosure. The System 1101 may include the ASA controller 1100 that can directly receive and transmit information, signals, data, instructions, commands, bits, symbols and the like with system eNBs. The System 1101 may also include system eNBs, such as the eNB 1102, that can directly receive and transmit information, signals, data, instructions, commands, bits, symbols and the like to the ASA controller 1100. The eNB 1102 may include one or more components of transmitter the system 210 illustrated in FIG. 2, which may be organized or configured as modules of the eNB 1102. The ASA controller 1100 may communicate with the eNB 1102 operated by a MNO via ASA-MNO interface 1120.

The ASA controller 1100 may include a memory 1104 that may store data and program codes for execution of policy determining module 1112 to determine one or more policies containing ASA information and a request receiving module 1114 to directly receive and respond to one or more communication requests and/or resource requests from the eNB 1102 based on the ASA information. The eNB 1102 may directly request to access an ASA system in order to utilize an ASA frequency spectrum. The ASA controller 1100 may also include a processor 1106 to perform or execute program codes that are stored in memory the 1104. The processor 1106 and/or other processor at the ASA controller 1100 may also perform or direct the execution of the functional blocks illustrated in FIG. 9, and/or other processes for the techniques described here.

The eNB 1102 may include a memory 1108 that may store data and program codes for execution of a policy receiving module 1116 to receive one or more policies containing ASA information from the OAM and a communication requesting module 1118 to request direct communication with the ASA controller based on received ASA information in order to request to access an ASA system in order to utilize an ASA frequency spectrum. The eNB 1102 may also include a processor 1110 to perform or execute program codes that are stored in memory 1108. The processor 1110 and/or other processor at the eNB 1102 may also perform or direction the execution of the functional blocks illustrated in FIG. 10, and/or other processes for the techniques described here.

In FIG. 11, a UE 1122 may communicate with the eNB 1102. The UE 1122 may communicate with the eNB 1102 on a frequency spectrum provided by one or more MNOs. If the eNB 1102 has registered itself with the ASA controller 1100, the UE 1122 may communicate with the eNB 1102 on both the frequency spectrum provided by the MNO and the ASA frequency spectrum.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 3-10 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any combinations thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
obtaining, by an Authorized Shared Access (ASA) controller, a policy associated with access to one or more ASA resources;
receiving, by the ASA controller directly from a base station, a communication request; and
establishing a communication interface directly between the ASA controller and the base station in response to the communication request.

2. The method of claim 1, further comprises directly responding, by the ASA controller to the base station, to a resource request received from the base station based on the policy.

3. The method of claim 2, wherein the directly responding to the resource request comprises providing current availability of one or more ASA frequencies in an ASA frequency spectrum requested by the base station.

4. The method of claim 1, further comprising rejecting one or more resource requests from one or more base stations if the base station that has been granted use of an ASA frequency spectrum has higher priority to use the ASA frequency spectrum than the one or more base stations.

5. The method of claim 4, further comprises executing pre-emption if the base station that has been granted use of the ASA frequency spectrum has lower priority than the one or more base stations.

6. The method of claim 1, further comprising directly prompting, by the ASA controller in response to the communication request, the base station to register with the ASA controller.

7. The method of claim 1, wherein the policy is programmed in the ASA controller.

8. The method of claim 1, wherein the policy is received from an Operation, Administration and Maintenance server (OAM) of a mobile network operation (MNO) in a Radio Access Network (RAN) domain.

9. The method of claim 8, wherein the policy received from the OAM of the MNO includes one or more potential network configurations for usage of an ASA frequency spectrum.

10. The method of claim 1, wherein the policy includes one or more of:
an ASA configuration including an ASA frequency spectrum;
a plurality of priority levels associated with a plurality of resource requests from a plurality of base stations;
a first rule indicating how the ASA controller prioritizes the plurality of resource requests from the plurality of base stations;
a group label indicating a set of base stations or an area including multiple base stations such that they are treated collectively;
a second rule indicating how the ASA controller responds to one or more resource requests from one or more base stations that are indicated by the group label;
a list of the plurality of base stations; and
a third rule indicating how the ASA controller responds to each of the plurality of resources requests from the plurality of base stations.

11. The method of claim 1, wherein the ASA controller is coupled with an ASA repository and obtains usage information of an ASA frequency spectrum by an incumbent user from the ASA repository.

12. The method of claim 1, further comprising receiving information from the base station, wherein the information includes one or more of:
a location of the base station;
a cell parameter of the base station;
a priority level of the base station;
a label of the base station; and
one or more frequencies requested by the base station.

13. A wireless communication apparatus comprising:
at least one processor; and
a memory coupled to the at least one processor, wherein the at least one processor is configured:
to obtain a policy associated with access to one or more ASA resources;
to receive a communication request from a base station; and
to establish a communication interface directly between an ASA controller and the base station in response to the communication request.

14. The apparatus of claim 13, wherein the at least one processor is further configured:
to reject one or more resource requests from one or more base stations if the base station that has been granted use of an ASA frequency spectrum has higher priority to use the ASA frequency spectrum than the one or more base stations; and
to execute pre-emption if the base station that has been granted use of the ASA frequency spectrum has lower priority than the one or more base stations.

15. The apparatus of claim 13, wherein the policy is one of:
programmed in the ASA controller; or
received from an Operation, Administration and Maintenance server (OAM) of a mobile network operation (MNO) in a Radio Access Network (RAN) domain, wherein the policy received from the OAM of the MNO includes one or more potential network configurations for usage of an ASA frequency spectrum.

16. The apparatus of claim 13, wherein the policy includes one or more of:
an ASA configuration including an ASA frequency spectrum;
a plurality of priority levels associated with a plurality of resource requests from a plurality of base stations;
a first rule indicating how the ASA controller prioritizes the plurality of resource requests from the plurality of base stations;
a group label indicating a set of base stations or an area including multiple base stations such that they are treated collectively;
a second rule indicating how the ASA controller responds to one or more resource requests from one or more base stations that are indicated by the group label;
a list of the plurality of base stations; and
a third rule indicating how the ASA controller responds to each of the plurality of resources requests from the plurality of base stations.

17. A method of wireless communication, comprising:
receiving, by a base station, a policy containing ASA information;
directly requesting, by the base station, communication with an Authorized Shared Access (ASA) controller based on the received ASA information; and
establishing a communication interface directly between the base station and the ASA controller.

18. The method of claim 17, wherein the receiving the policy comprises receiving the policy from an Operation, Administration and Maintenance server (OAM) of a mobile network operator (MNO) in a Radio Access Network (RAN) domain.

19. The method of claim 18, further comprising:
reporting, by the base station, operational changes to the OAM, wherein the policy received from the OAM is changed based on operational changes reported from the base station.

20. The method of claim 17, wherein the policy includes one or more of:
an ASA configuration including an ASA frequency spectrum and potential availability of the ASA frequency spectrum to the base station;
an identity of the ASA controller for the base station to contact for each ASA frequency in the ASA frequency spectrum or geographical area;
a plurality of priority levels associated with a plurality of resource requests from a plurality of base stations;
a group label indicating a set of base stations or an area including multiple base stations such that they are treated collectively;
a condition under which the base station initiates a resource request; and
expectation of the availability of the ASA frequency spectrum.

21. The method of claim 17, further comprising directly requesting to use an ASA frequency spectrum based on the received ASA information.

22. The method of claim 17, further comprising transmitting information to the ASA controller, wherein the information includes one or more of:
a location of the base station;
a cell parameter of the base station;
a priority level of the base station;
a label of the base station; and
one or more frequencies requested by the base station.

23. The method of claim 17, further comprising examining the policy and determining whether to directly request the communication with the ASA controller based on the examined policy.

24. The method of claim 17, wherein the base station is a HeNB which is provided with ASA configuration by a HeNB Management System.

25. A wireless communication apparatus comprising:
at least one processor; and
a memory coupled to the at least one processor, wherein the at least one processor is configured:
to receive a policy containing ASA information;
to directly request communication with an Authorized Shared Access (ASA) controller based on the received ASA information; and
to establish a communication interface directly between a base station and the ASA controller.

26. The apparatus of claim 25, wherein the configuration of the at least one processor:
to receive the policy comprises configuration to receive the policy from an Operation, Administration and Maintenance server (OAM) of a mobile network operator (MNO) in a Radio Access Network (RAN) domain; and
to report operational changes to the OAM, wherein the policy received from the OAM is changed based on operational changes reported from the base station.

27. The apparatus of claim 25, wherein the policy includes one or more of:
an ASA configuration including an ASA frequency spectrum and potential availability of the ASA frequency spectrum to the base station;
an identity of the ASA controller for the base station to contact for each ASA frequency in the ASA frequency spectrum or geographical area;
a plurality of priority levels associated with a plurality of resource requests from a plurality of base stations;
a group label indicating a set of base stations or an area including multiple base stations such that they are treated collectively;
a condition under which the base station initiates a resource request; and
expectation of the availability of the ASA frequency spectrum.

28. The apparatus of claim 25, wherein the at least one processor is configured to directly request to use an ASA frequency spectrum based on the received ASA information.

29. The apparatus of claim 25, wherein the at least one processor is further configured to examine the policy and to determine whether to directly request the communication with the ASA controller based on the examined policy.

30. The apparatus of claim 25, wherein the base station is a HeNB which is provided with ASA configuration by a HeNB Management System.
